(19) United States
(12) Patent Application Publication
(10) Pub. No.: US 2014/0231334 A1
(43) Pub. Date: Aug. 21, 2014

(54) FILTER SYSTEM FOR A LIQUID MEDIUM

(71) Applicant: Johannes Jaenen, Troisdorf (DE)

(72) Inventor: Johannes Jaenen, Troisdorf (DE)

(73) Assignee: Mayfran International B.V.

(21) Appl. No.: 13/261,827

(22) PCT Filed: Aug. 31, 2012
(86) PCT No.: PCT/DE2012/100257

§ 371 Date: Mar. 10, 2014

(30) Foreign Application Priority Data
Sep. 9, 2011 (DE) 10 2011 053 424.5

(51) Int. Cl. B01D 29/66

(52) U.S. Cl. CPC B01D 29/66
USPC 210/333.01; 210/411

(57) ABSTRACT

A filter system for a liquid medium is suggested, comprising at least one filter module (1, 100) with at least two vessel units, each of which has an outer side wall (4, 6), wherein one of the vessel units forms a closed filter housing (2, 102) and each other vessel unit forms a tank element. The filter systems is characterized in that one of the vessel units, as an inner vessel unit is enclosed along at least a larger part of the periphery of its side wall (4, 6), by the other vessel unit or, in the case of at lease three vessel units, by at least one of the other vessel units.

The invention relates to a filter system for a liquid medium according to the preamble of claim 1.

The liquid medium can be, for example, a working means, preferably a cooling lubricant, as used in machining work, in particular in the metal-producing industry. A filter system of the type mentioned at the beginning is known, for example, from DE 10 2007 049 658 A1. Said document discloses a filter module which has a filter housing with filter elements arranged therein, a pure tank and a dirt tank. Unfiltered material is supplied from an unfiltered material source, for example from an outlet for contaminated cooling lubricant from one or more machine tools, to the dirt tank. From the dirt tank, the unfiltered material is supplied to an unfiltered material side of the filter housing by means of a pump and the liquid medium is pressed through the filter elements. From the filtered material side, the filtered material is supplied to the pure tank, from where said filtered material is supplied to its further destination, for example in the form of fresh cooling lubricant for machine tools.

From time to time, the filter elements are subjected to cleaning by means of a backwashing process. To this end, the cited prior art discloses first of all suppressing the supply of unfiltered material and the removal of filtered material and of conducting the unfiltered material remaining in the filter container into the dirt tank. Subsequently, any filtered material still remaining is pressed through the filter elements by means of compressed air such that the filter cake is detached from the filter elements. The detached material is supplied to the dirt tank—optionally via a further filter step. Finally, the cleaning process can be continued by means of compressed air which is pressed through the filter elements. After the cleaning, the filter process can be started up again. The filter system is not available for filtering unfiltered material during the cleaning process.

The size and capacities of filter systems are determined by the underlying application; in the metal-processing industry, for example, by the size and number of machine tools and the resultantly predetermined requirement for cooling lubricants. If a requirement changes, for example, in the event of the machining capacities increasing, the filter system frequently also has to be adapted. This means either a costly reprocurement of the entire system or of at least individual parts, such as, for example, the filter housing and the tanks, or additional filter housings and/or tanks which have to be connected to the existing system are provided. In addition, the known filter systems require a considerable and costly amount of space.

The invention is therefore based on the technical problem of providing a filter system of the type mentioned at the beginning, which is constructed in a space-saving manner and is suitable in a particular manner for adaptation to changing filter requirements.

This object is achieved in the case of a filter system of the type mentioned at the beginning by the features of claim 1. Advantageous embodiments are provided by the dependent claims.

According thereto, provision is made for one container unit of the filter module to surround the other. For example, the filter housing can be surrounded by a first tank, for example the dirt tank. If at least one second tank, for example the pure tank, is required, this can be arranged nested in a corresponding manner, for example surrounding the dirt tank. It is also possible to design the filter housing so as to annularly surround one of the tanks or even all of the tank units.

The sequence of the different container units is interchangeable. The outer side of the side wall of an inner container unit here can serve at the same time as an inner wall of the container unit surrounding said inner container unit. If the innermost container unit is provided, for example, by the filter housing, a portion of the outer wall of the filter housing can serve at the same time as a boundary for the surrounding tank, for example the dirt tank. The outer wall of said dirt tank can then, for example, also form the inner wall of the pure tank surrounding said dirt tank annularly. This shell-like construction of the container units is space-saving in a particular manner. In addition, the pipelines required between the container units are thereby spared or can at least be designed to be very short.

If one container unit surrounds the other, this can be completely in the context that the side wall of the inner container unit is completely enclosed by the other container unit.

In an advantageous embodiment, the enclosing of the inner container unit can also be designed, however, to be incomplete, in the context that lateral access to the inner container unit still remains, for example for maintenance work or—if the inner container unit is the filter housing—to facilitate the removal or exchange of filter units, for example filter cartridges. For this purpose, for example, the outer container unit can enclose merely at least 60%, preferably at least 70%, furthermore preferably at least 75% of the extent of the side wall. Alternatively, the inner container unit can be enclosed in one or more specific regions over the full extent by the outer container unit whereas at least one other region remains free for access. If the inner container unit is surrounded by a plurality of other container units, the access to the inner container unit can be left free by suitable arrangement of the container unit(s) arranged further on the outside. Lateral access is particularly advantageous if a given room height is intended to be used as completely as possible for the height of the filter module.

The container units are carried by a carrier structure, wherein at least one carrying element of the carrier structure can serve at the same time as a fluid line. Fluid lines can thereby be spared within a certain framework.

The filter module consisting of the container units and the carrier structure can be dimensioned in terms of the outer dimensions thereof by means of its compact construction in such a manner that it can be transported its entirety by means of roadworthy transporters, for example by means of a truck, without a special license for excess sizes.

The filter system according to the invention can consist of a single filter module. However, a filter module can also be designed in such a manner that it is couplable to further filter modules. The filter system can thereby be expanded in a fundamentally arbitrary manner. A basic module which is functional by itself and is useable as the filter system can be used as the basic element by the user. When required and when increasing the capacities, addition of further modules is possible. For this purpose, coupling elements can already be provided on the filter module in order to provide the necessary connections between the filter modules. Conversely, in the event of a reduction in requirements, individual modules can also be removed.

If the filter system consists of at least two modules, it is moreover possible to clean one of the modules while the at least one further filter module can further filter the liquid medium. In particular in the event of a greater number of filter modules, the cleaning operation can be carried out in an optimum manner without the filter process as a whole being negatively influenced as a result.

In particular, it is possible couple the tank elements of different filter modules to one another via fluid lines in such a manner that they can be used as a common tank. This has advantages in particular also for cleaning the filters. The tank contents of the filter module to be cleaned and, in addition, the tank contents of the further filter modules can thus be used for the filter cleaning process. By this means, the maximum cleaning time available can be extended, with the result of an improvement in the process quality, for example by means of an extended precoating time or an extended drying time for the filter cake.

In the event of a greater number of filter modules, one of the filter modules may be operated redundantly. A filter module which is to be cleaned or a damaged filter module can therefore be replaced by the redundant filter module and a negative influence of the cleaning of the filter or of the damage on the filter process can be avoided.

Filter systems can consist, for example, of 5 or 6 filter modules. This order of magnitude can ensure a substantially fault-free, continuous filtering operation. However, if an extraordinarily large amount of cooling lubricant is required, a filter system according to the invention can also consist of more than six filter modules. If a correspondingly small amount of cooling lubricant is required, the individual operation of a filter module or a filter system consisting of 2, 3 or 4 filter modules may also be expedient.

The coordination of the filter modules with one another can be achieved by a correspondingly designed controlling means, for example by a master controlling means controlling one or more filter modules, wherein the filter modules can in each case have a slave controlling means which is dependent on the master controlling means.

Preferred exemplary embodiments of the filter system according to the invention are illustrated below with reference to figures, in which, schematically:

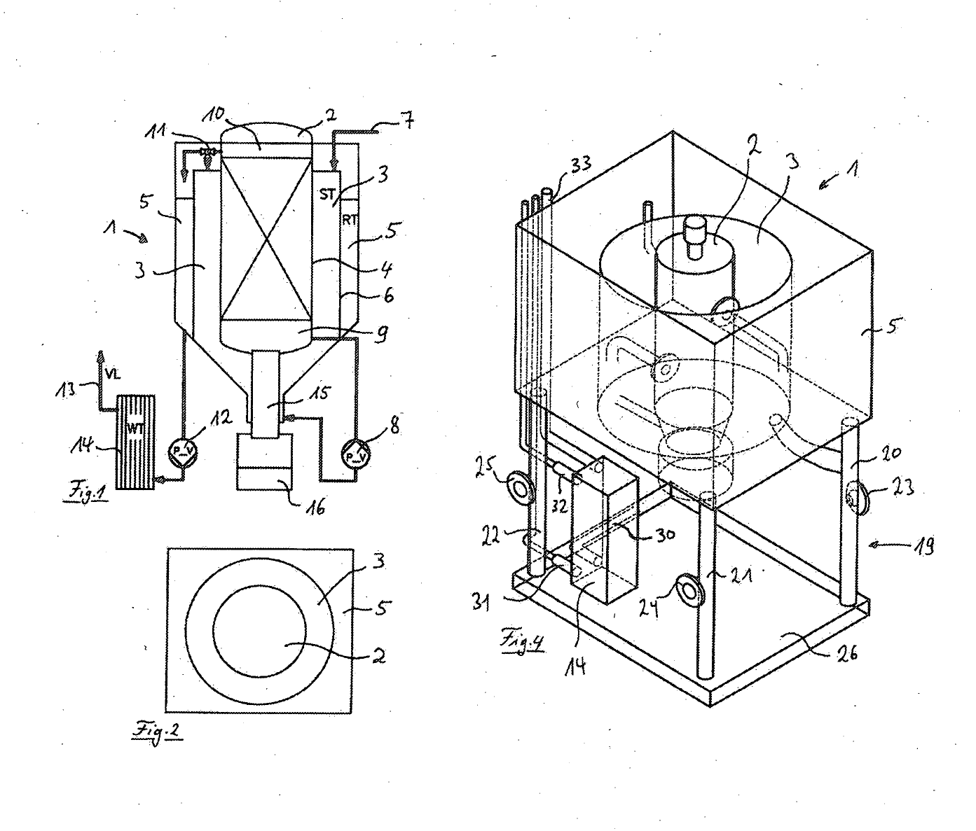

FIG. 1 shows a filter module in lateral cross section,

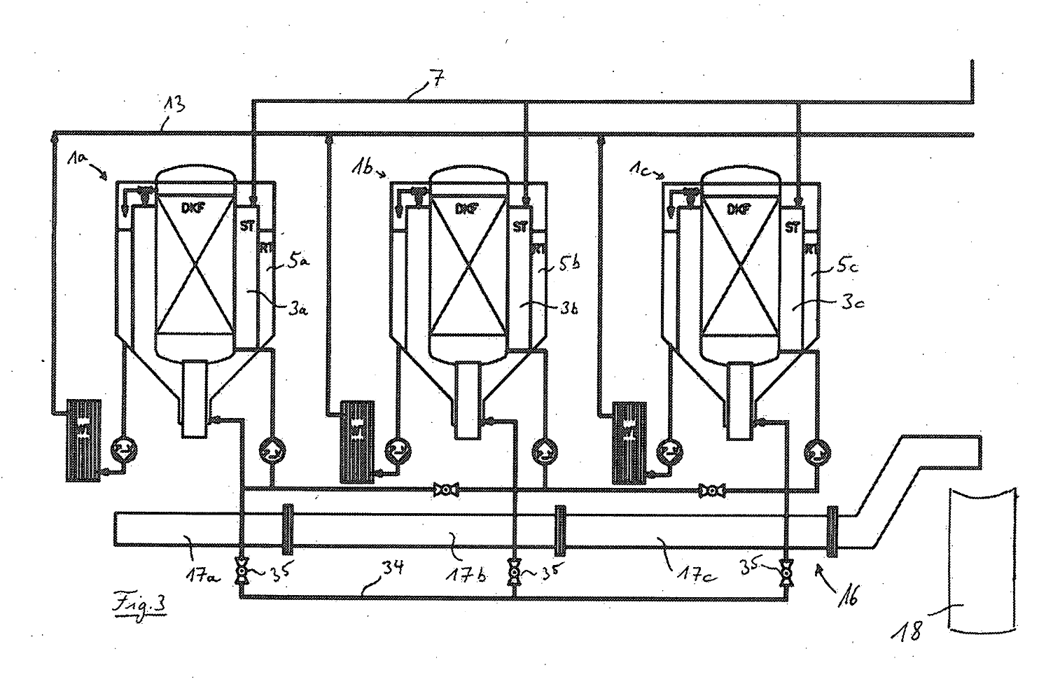

FIG. 2 shows a top view of the filter module according to FIG. 1 in a cross section,

FIG. 3 shows a filter system with three filter modules,

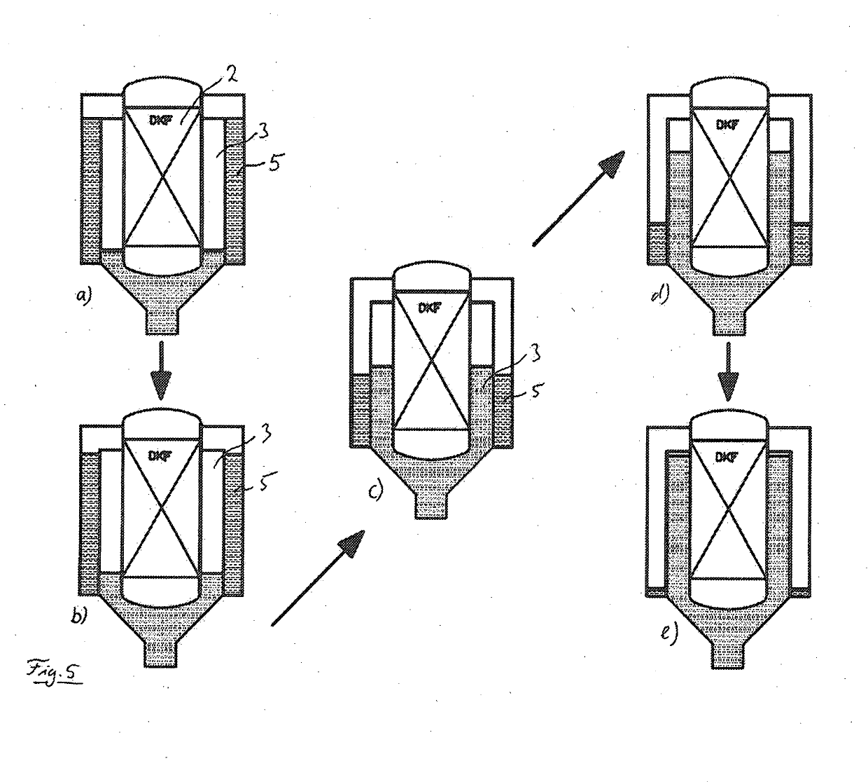

FIG. 4 shows a filter module in a perspective illustration with supporting structure elements,

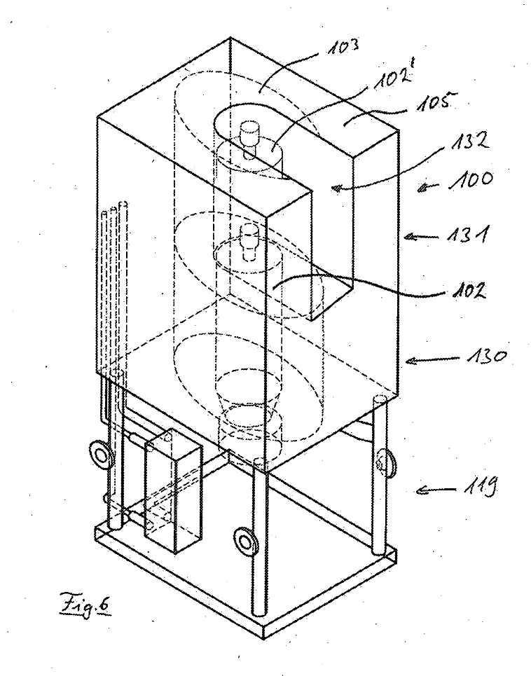

FIG. 5 shows a schematic illustration of the generation phase, and

FIG. 6 shows an alternative embodiment of a filter module.

FIG. 1 schematically shows a filter module 1 in a lateral cross section. A filter container 2 with filter cartridges (not illustrated specifically here) is surrounded by a dirt tank 3. An outer wall 4 of the filter container 2 therefore at the same time forms an inner wall of the dirt tank 3. The dirt tank 3 is surrounded by a pure tank 5, wherein an outer wall 6 of the dirt tank 3 at the same time forms an inner wall of the pure tank 5. By filter container 2, dirt tank 3 and pure tank 5 being placed one inside another a highly space-saving concept is provided for the filter module 1.

FIG. 2 shows a top view of the filter module 1 according to FIG. 1 in a cross section.

A filter module 1 of the type in question here can serve as a filter system for the cooling lubricant of machine tools (not illustrated here). Soiled cooling lubricant originating, for example, from the machine tools passes via a cooling lubricant return 7 into the dirt tank 3. Polluted cooling lubricant is pumped out of the dirt tank 3 into an unfiltered material chamber 9 of the filter container 2 by an unfiltered material pump 8. Via a pressure difference, the unfiltered material is pressed through the filter cartridges (not illustrated here) and thereby filtered. By this means, a filtered material chamber 10 of the filter container is filled with filtered material. The filtered material, the filtered cooling lubricant, passes via a 3-way directional control valve 11 into the pure tank 5, from where the filtered material is supplied via a filtered material pump 12 to a cooling lubricant forward feed 13 for the cooling lubricant and therefore is supplied again directly, or indirectly via a cooling lubricant container (not illustrated here), to the machine tools. The filtered material is conducted here via a heat exchanger 14 in order to remove heat from the cooling lubricant. If the pure tank 5 is filled to a predetermined limit value, the filtered material is passed back via an overflow (not illustrated) into the dirt tank 3.

The filter container 2 has an ejection shaft 15 for the filter cake. The regeneration of the filter module 1 is illustrated further below. A conveying system 16 for removing the ejected filter cake is located below the ejection shaft 15.

FIG. 3 shows a filter system consisting of three filter modules 1a, 1b and 1c, which are all constructed in a corresponding manner. With regard to the construction of the individual filter modules 1a, 1b and 1c, reference is made to the description with regard to FIGS. 1 and 2.

All of the dirt tanks 3a, 3b and 3c of the filter modules 1a, 1b and 1c are connected to the cooling lubricant return 7. Similarly, each filter module 1a, 1b and 1c feeds into the cooling lubricant forward feed 13.

Individual conveying elements 17a, 17b and 17c of the conveying system 16 can be seen below the filter modules 1a, 1b and 1c. The conveying elements 17 are connected to one another, and therefore a filter cake collected by this means passes into a filter cake collecting container 18.

The modular construction of the filter system according to FIG. 3 makes it possible to regenerate any one of the filter modules 1a, 1b or 1c while the machine tools continue to be supplied with filtered cooling lubricant from the pure tanks 5a, 5b and 5c of all of the modules 1a, 1b and 1c.

Provision is generally made to top up the quantity of cooling lubricant from a storage container (not illustrated here) when required. This can take place, for example, by admission into one of the pure tanks 5a, 5b or 5c.

The dirt tanks 3a, 3b and 3c are connected to one another via an equalizing line 34. By means of suitable valve elements 35 and/or closure elements, individual modules 1a, 1b or 1c can be shut off manually or automatically from the equalizing line 34. In a corresponding manner (not illustrated here), the pure tanks 5a, 5b and 5c can also be connected to one another via an equalizing line with a shut-off option. The equalizing lines permit an exchange of the corresponding liquid, for example according to the principle of communicating pipes, between the tanks connected in this manner.

The filter modules 1a, 1b and 1c of the filter system according to FIG. 3 are coordinated with one another in the controlling means of the respective pumps, wherein a master control unit (not illustrated here) which the slave controlling means of the modules 1a, 1b and 1c follow is provided. The illustration in FIG. 3 is of a schematic type. Further elements, in particular valves, shut-off elements or the like, which are expedient for the operation can be provided.

FIG. 4 shows perspectively a filter module 1 including a supporting structure 19. Said supporting structure 19 carries pure tank 5, dirt tank 3 and filter container 2 and comprises supporting pipes 20, 21 and 22 which are placed on a base element 26, are of hollow design and, in addition to the supporting function thereof, serve as fluid lines. A fourth supporting pipe is likewise present and is placed in the rear corner of the base element 26 and is not visible in the illustration. Furthermore, the supporting pipes 20, 21 and 22 have coupling points 23, 24 and 25 (if required, also a further coupling point on the fourth, nonvisible supporting pipe) via which adjacent filter modules 1 can be connected to one another in order to exchange cooling lubricant (filtered or unfiltered) with one another.

Via the fluid lines of the rear two supporting pipes 22, fluid is equalized between the pure tanks 5 of filter modules 1 coupled to one another. In addition, the suction via the filtered material pump 12 (see FIG. 1) can be connected here, said filtered material pump supplying filtered cooling lubricant from the pure tank 5 via an intake 30 to the heat exchanger 14 and on via the connecting line 33 to the cooling lubricant forward feed 13. In addition, cooling water inlet 31 and cooling water outlet 32 are connected to the heat exchanger 14.

The supporting pipes 20 and 21 are in each case connected to the dirt tank 3 and ensure an equalization of fluid between the dirt tanks 3 of filter modules 1 which are coupled to one another.

FIG. 5 clarifies a regeneration operation in a filter module 1, in which the different phases of the regeneration are illustrated at the same filter module 1.

FIG. 5a shows the filter module 1 in filtering mode, wherein the pure tank 5 is filled to 100%.

At the beginning of the regeneration, the filter container 2 is emptied by the contents thereof (filtered material and unfiltered material) being discharged into the dirt tank 3. The pure tank 5 here continues to supply the machine tools with cooling lubricant, and therefore the degree of filling of said pure, tank decreases over the various phases of the regeneration (FIG. 5b)). If the filter container 2 is at least virtually completely freed from liquid, the filter cake, after a possible intermediate step of drying the filter cake by means of compressed air, is detached from the filter cartridges, for example by a shock pulse. The cake can escape through the ejection shaft 15 (not illustrated in FIG. 5) (see FIG. 1) and is removed via the conveying system 16 (likewise not illustrated in FIG. 5) (FIG. 3). At this time, the degree of filling of the pure tank 5 has decreased further and that of the dirt tank 3 has increased. The change in the degree of filling arises from the coupling to further filter modules 1 in association with the retrieval of filtered cooling lubricant and the supply of soiled cooling lubricant by the machine tools.

However, for optimum operation of the filter, filter cartridges require a certain filter cake coating, since this significantly improves the filtering effect. Owing to this requirement, liquid from the dirt tank 3 is coated onto the filter cartridges, and therefore a filter cake extension is again formed there. After the filter cake has been adequately coated or after the volumes of the various pure tank containers have been fully used for the purpose of regeneration, the filtered material is supplied back to the pure tank 5 and the operation of the filter is started up again (FIG. 5e).

FIG. 6 shows an alternative form of a filter module 100, with container units—filter container 102, dirt tank 103 and pure tank 105—which are changed by comparison to the filter module 1 according to FIGS. 1 to 5.

In a lower part 130 of the container complex, the filter container 2 is completely surrounded by the dirt tank 103 and the latter, in turn, is completely surrounded by the pure tank 105. In an upper partial region 131, both the dirt tank 103 and the pure tank 105 have a common access recess 132 which permits access to the filter container 102. The filter container 102 is illustrated by dashed lines in the operating position thereof. The upper position, which is adequate for lateral removal of the filter elements, of an upper cover element of the filter container 102, said cover element being able to be raised together with the filter elements, is provided with the reference number 102′. Dirt tank 103 and pure tank 105 can therefore fully utilize the room height of an installation room, since the filter elements of the filter container 102 no longer have to be raised upward beyond the dirt tank 103 and pure tank 105 for removal purposes. The container contents of dirt tank 103 and pure tank 105 can thereby be optimized in respect of the available room height.

A supporting structure 119 and the rest of the construction of the filter module 100 corresponds to the filter module 1 according to FIGS. 1 to 5.

List of reference numbers

| | |
|---|---|
| 1 | Filter module |
| 2 | Filter container |
| 3 | Dirt tank |
| 4 | Outer wall of the filter |
| | container |
| 5 | Pure tank |
| 6 | Outer wall of the dirt |
| | tank |
| 7 | Cooling lubricant return |
| 8 | Unfiltered material pump |
| 9 | Unfiltered material |
| | chamber |
| 10 | Filtered material |
| | chamber |
| 11 | 3-way directional |
| | control valve |
| 12 | Filtered material pump |
| 13 | Cooling lubricant |
| | forward feed |
| 14 | Heat exchanger |
| 15 | Ejection shaft |
| 16 | Conveying system |
| 17 | Conveying element |
| 18 | Filter cake collecting |
| | container |
| 19 | Supporting structure |
| 20 | Supporting pipe |
| 21 | Supporting pipe |
| 22 | Supporting pipe |
| 23 | Coupling point |
| 24 | Coupling point |
| 25 | Coupling point |
| 26 | Base element |
| 30 | Cooling lubricant inlet |
| 31 | Cooling water inlet |
| 32 | Cooling water outlet |
| 33 | Connecting line |
| 34 | Equalizing line for dirt |
| | tanks |
| 100 | Filter module |
| 102 | Filter container |
| 103 | Dirt tank |
| 105 | Pure tank |
| 119 | Supporting structure |
| 130 | Lower part of container |
| | complex |
| 131 | Upper part of container |
| | complex |
| 132 | Access recess |

1-14. (canceled)

15. A filter system for a liquid medium, comprising at least one filter module (1, 100), which is regenerable by a backwashing process, having at least two container units, each having an outer side wall (4, 6), wherein one of said container units forms a closed filter housing (2, 102) having a filter and each other container unit in each case forms a tank element, and said filter housing has a filter cake ejection shaft (15) which is arranged below said filter and is oriented downward for the ejection, characterized in that one of said container units, as an inner container unit, is surrounded along at least a predominant portion of the extent of said side wall (4, 6) thereof by the other container unit or, in the case of at least three container units, is surrounded by at least one of the other container units.

16. The filter system as claimed in claim 15, wherein the innermost container unit is said filter housing (2, 102).

17. The filter system as claimed in claim 15, wherein two tank elements are provided, wherein one of said two tank elements is a pure tank (5) and the other tank element is a dirt tank (3).

18. The filter system as claimed in claim 15, wherein said filter housing (2, 102) is surrounded by at least one tank element only along a portion of said side wall (4, 6) in such a manner that the at least one tank element leaves an access opening (132) to said side wall (4, 6) of said filter housing (2, 102) free.

19. The filter system as claimed in claim 15, wherein at least one portion of an outside of said side wall (4, 6) of an inner one of said container units forms at least one portion of said inner wall of the container unit surrounding said inner container unit.

20. The filter system as claimed in claim 15, wherein said container units are carried by a supporting structure (19, 119), wherein at least one carrying element (20, 21, 22) of said supporting structure (19, 119) serves as a fluid line.

21. The filter system as claimed in claim 15, wherein said at least one filter module (1, 102) has at least one coupling element (23, 24, 25) for the connection of a fluid-transferring element.

22. The filter system as claimed in claim 21, wherein at least one of said coupling elements (23, 24, 25) is provided on said supporting structure (19, 119).

23. The filter system as claimed in claim 15, wherein at least two filter modules (1, 100) are provided, wherein said filter modules (1, 100) are connected to one another in order to exchange fluids with one another between said tank elements of different filter modules (1, 100).

24. The filter system as claimed in claim 23, further comprising at least three filter modules (1, 100), wherein said pure tank (5, 105) and/or said dirt tank (3, 103) of at least one of said filter modules (1, 100) is (are) connected to the corresponding tank elements of at least two other filter modules via fluid-transferring elements.

25. The filter system as claimed in claim 23, wherein a dedicated module control unit for controlling fluid flows between said container units and/or between said filter modules (1, 100) is provided for each filter module (1, 100).

26. The filter system as claimed in claim 25, wherein a master control unit is provided for controlling said filter system, and each module control unit is designed as a slave control unit which is subordinate to said master control unit.

27. The filter system as claimed in claim 15, wherein said filter module (1, 100) or at least one of said filter modules (1, 100) has a filter cake removal apparatus (16, 17).

28. The filter system as claimed in claim 27, wherein said filter cake removal apparatuses (16, 17) of adjacent filter modules (1, 100) are couplable to each other.
